(19) United States
(12) Patent Application Publication
(10) Pub. No.: US 2025/0239858 A1
(43) Pub. Date: Jul. 24, 2025

(54) POWER CAPSULE VIRTUAL POWER PLANT METHOD, SYSTEM AND DEVICE INCLUDING ARTIFICIAL INTELLIGENT CONTROL

(71) Applicant: POWER8 TECH INC., LOS GATOS, CA (US)

(72) Inventors: Lien Chun Ding, Taoyuan (TW); Chih Cheng Tai, Campbell, CA (US)

(21) Appl. No.: 19/062,484

(22) Filed: Feb. 25, 2025

Related U.S. Application Data
(63) Continuation-in-part of application No. 18/199,745, filed on May 19, 2023, now Pat. No. 12,234,797.
(60) Provisional application No. 63/345,274, filed on May 24, 2022.

(51) Int. Cl. H02J 3/38; H02J 3/46

(52) U.S. Cl. CPC H02J 3/381; H02J 3/466; H02J 2203/20

(57) ABSTRACT

A virtual power plant system including a network of sense and control devices communicatively coupled with a virtual power plant control center that receives data about distributed power generating facilities, power storage apparatuses, power transmission nodes and/or power consumption entities from the devices and optimizes the process of energy generation, storage, re-generation, transmission and/or consumption throughout the network based on the received data.

### CROSS-REFERENCE TO RELATED APPLICATIONS

This application is a continuation-in-part (CIP) of the copending U.S. patent application Ser. No. 18/199,745, filed on May 19, 2023, and entitled “SMART CONTROLLING SYSTEMS FOR ENERGY STORAGE,” which claims priority to the U.S. Provisional Application No. 63/345,274, filed on May 24, 2022, and entitled “SMART CONTROLLING SYSTEMS FOR ENERGY STORAGE” and is a continuation-in-part (CIP) of the copending U.S. patent application Ser. No. 17/777,516, filed on May 17, 2022, and entitled “ENERGY STORAGE SYSTEMS AND METHODS USING HETEROGENEOUS PRESSURE MEDIA AND INTERACTIVE,” which is a National Stage of PCT/US2022/029374, filed on May 16, 2022, and entitled “ENERGY STORAGE SYSTEMS AND METHODS USING HETEROGENEOUS PRESSURE MEDIA AND INTERACTIVE ACTUATION MODULE,” which claims a priority to CN202111466565.5, filed on Dec. 3, 2021, and entitled “ENERGY STORAGE SYSTEMS AND METHODS USING HETEROGENEOUS PRESSURE MEDIA AND INTERACTIVE ACTUATION MODULE.”

All of the above are incorporated herein by reference for all purposes.

### FIELD OF THE INVENTION

The present invention relates to green (renewable) energy power generation, storage and control. Specifically, the present invention relates to a virtual power plant system.

### BACKGROUND OF THE INVENTION

Typical energy storage systems are either not safe, not efficient, or impractical.

### SUMMARY OF THE INVENTION

A virtual power plant system, method and device including a network of sense and control devices communicatively coupled with a virtual power plant control center that receives data about power generating facilities, power storage apparatuses, power transmission nodes and/or power consumption entities from the devices and optimizes the process of energy generation, storage, re-generation, transmission and/or consumption throughout the network based on the received data.

As a result, the virtual power plant system, method and device is able to provide the advantage of providing real-time monitoring, dynamic dispatching, and self-regulation of each of the elements of the virtual power plant system (e.g. generation facilities, storage apparatuses, transmission nodes, consumption entities, etc.) to address challenges in energy structure diversification and changing electricity demands. Specifically, the system, method and device is able to integrate geographically dispersed, small-scale but dispatchable power generators (e.g. facilities or smaller electrical power generation elements) and small-scale frequency regulation energy storage units into a system that, in logical terms, functions as a large centralized power plant. Thus, the virtual power plant system, method and device is able to provide the benefits of aggregating multiple resources to provide a unified market interface, optimizing resource scheduling and dynamically responding to power supply and demand changes, and enhancing overall grid stability and flexibility.

A first aspect of the application is directed to a virtual power plant system. The system comprises a virtual power plant system comprising one or more energy storage apparatuses, wherein each of the energy storage apparatuses is configured to store an amount of received electricity by pumping a corresponding amount of fluid to increase a gas pressure inside the energy storage apparatus and to release a portion or all of the amount of received electricity by pushing out a portion or all of the corresponding amount of fluid to generate an amount of released electricity by driving a hydrogenerator and an energy distribution and controlling system dynamically and selectively controlling modes of electricity storing or electricity generating of a selected one or more of the one or more energy storage apparatuses based on an electricity consumption status.

In some embodiments, the virtual power plant system further comprises one or more power generation facilities for generating electricity coupled to the one or more energy storage apparatuses to deliver the electricity to the energy storage apparatuses, wherein each of the power generation facilities includes a facility controller device that senses a facility status of the power generation facility. In some embodiments, each of the one or more energy storage apparatuses comprise a first fluid container for accommodating a liquid and a gas, a pump configured to pump the liquid into the first fluid container to compress the gas in the first fluid container using the electricity thereby storing energy, a hydrogenerator driven by the liquid coming out from the first fluid container to generate electrical power using the stored energy and an apparatus controller for sensing an apparatus status of the energy storage apparatus, one or more electrical consumption entities each including an entity controller for sensing an entity status of the electrical consumption entity. In some embodiments, the virtual power plant system further comprises one or more electrical transmission nodes each including a node controller for sensing a node status of the electrical transmission node and electrically coupled between the one or more energy storage apparatuses and the one or more electrical consumption entities for receiving the electrical power from the apparatuses and transmitting the electrical power to the one or more electrical consumption entities. In some embodiments, the virtual power plant system further comprises a virtual power plant control center communicatively coupled with each of the facility controller devices, the apparatus controllers, the entity controllers and the node controllers for receiving the facility statuses, the apparatus statuses, the entity statuses and the node statuses, wherein the control center adjusts the generation of the electricity by the power generation facilities, the storage of the energy by the one or more energy storage apparatuses, the generation of the electrical power by the one or more energy storage apparatuses and the transmission of the electrical power by the one or more electrical transmission nodes based on the facility statuses, the apparatus statuses, the entity statuses and the node statuses. In some embodiments, the power generation facilities include one or more of a wind electric power generator, a water electric power generator, a solar electric power generator, and a heat electric power generator. In some embodiments, the one or more electrical consumption entities include one or more of an industrial plant, a commercial center, and a residential area. In some embodiments, the one or more electrical nodes include one or more of a distribution transformer, an electrical substation, and an electrical transmission tower. In some embodiments, the virtual power plant control center utilizes artificial intelligence to predict future electrical power demand at one or more of the electrical consumption entities and future electrical power generation capacity at one or more of the power generation facilities and the one or more energy storage apparatuses based on one or more of the facility statuses, the apparatus statuses, the entity statuses and the node statuses. In some embodiments, the virtual power plant control center adjusts the generation of the electricity by the power generation facilities, the storage of the energy by the one or more energy storage apparatuses, the generation of the electrical power by the one or more energy storage apparatuses and the transmission of the electrical power by the one or more electrical transmission nodes based on at least one of the predicted future electrical power demand and the predicted future electrical power generation capacity. In some embodiments, when adjusting the generation of the electricity by the power generation facilities, the storage of the energy by the one or more energy storage apparatuses, the generation of the electrical power by the one or more energy storage apparatuses and the transmission of the electrical power by the one or more electrical transmission nodes, the virtual power plant control center minimizes transmission distance to reduce electrical power loss. In some embodiments, when adjusting the generation of the electricity by the power generation facilities, the storage of the energy by the one or more energy storage apparatuses, the generation of the electrical power by the one or more energy storage apparatuses and the transmission of the electrical power by the one or more electrical transmission nodes, the virtual power plant control center prioritizes a subset of the one or more electrical consumption entities such that the subset receives power even when there is insufficient electrical power for all of the one or more electrical consumption entities. In some embodiments, each of the facility statuses include one or more of whether the facility is currently operational and a current electrical power generation capacity of the facility. In some embodiments, each of the apparatus statuses include one or more of whether the energy storage apparatus is currently operational, a current quantity of stored energy of the energy storage apparatus and a current electrical power generation capacity of the energy storage apparatus. In some embodiments, the entity statuses include one or more of whether the electrical consumption entity is currently operational, a current electrical load of the electrical consumption entity, a current quantity of stored energy of the electrical consumption entity and a current electrical power demand of the electrical consumption entity. In some embodiments, the node statuses include one or more of whether the electrical transmission node is currently operational, a current electrical load of the electrical transmission node, a current quantity of stored energy of the electrical transmission node and a current electrical power demand of the electrical transmission node. In some embodiments, each of the facility controller devices is able to control the power generation facility, each of the apparatus controllers is able to control the energy storage apparatus, each of the node controllers is able to control the electrical transmission node and each of the entity controllers is able to control the electrical consumption entity independent of commands received from the virtual power plant control center.

A second aspect of the application is directed to a method of operating a virtual power plant system comprising storing an amount of received electricity by pumping a corresponding amount of fluid to increase a gas pressure inside one or more energy storage apparatuses, releasing a portion or all of the amount of received electricity by pushing out a portion or all of the corresponding amount of fluid to generate an amount of released electricity by driving a hydrogenerator and dynamically and selectively controlling modes of electricity storing or electricity generating with an energy distribution and controlling system of a selected one or more of the one or more energy storage apparatuses based on an electricity consumption status.

In some embodiments, the method further comprises receiving, with a virtual power plant control center, a facility status from facility controller devices at each of one or more power generation facilities for generating electricity and delivering the electricity to the one or more energy storage apparatuses. In some embodiments, the method further comprises receiving, with the virtual power plant control center, an apparatus status from apparatus controller devices at each of the one or more energy storage apparatuses electrically coupled with the one or more power generation facilities for receiving the electricity generated by the one or more power generation facilities, wherein each of the one or more energy storage apparatuses comprise a first fluid container for accommodating a liquid and a gas, a pump configured to pump the liquid into the first fluid container to compress the gas in the first fluid container using the electricity thereby storing energy and a hydrogenerator driven by the liquid coming out from the first fluid container to generate electrical power using the stored energy. In some embodiments, the method further comprises receiving, with the virtual power plant control center, an entity status from entity controller devices at each of one or more electrical consumption entities, receiving, with the virtual power plant control center, a node status from node controller devices at each of one or more electrical transmission nodes electrically coupled between the one or more energy storage apparatuses and the one or more electrical consumption entities for receiving the electrical power from the one or more energy storage apparatuses and transmitting the electrical power to the one or more electrical consumption entities and adjusting the generation of the electricity by the one or more power generation facilities, the storage of the energy by the one or more energy apparatuses, the generation of the electrical power by the one or more energy storage apparatuses and the transmission of the electrical power by the one or more electrical transmission nodes with the virtual power plant control center based on the facility statuses, the apparatus statuses, the entity statuses and the node statuses. In some embodiments, the one or more power generation facilities include one or more of a wind electric power generator, a water electric power generator, a solar electric power generator, and a heat electric power generator. In some embodiments, the one or more electrical consumption entities include one or more of an industrial plant, a commercial center, and a residential area. In some embodiments, the one or more electrical transmission nodes include one or more of a distribution transformer, an electrical substation, and an electrical transmission tower. In some embodiments, further comprising utilizing artificial intelligence with the virtual power plant control center to predict future electrical power demand at one or more of the electrical consumption entities and future electrical power generation capacity at one or more of the power generation facilities and the one or more energy storage apparatuses based on one or more of the facility statuses, the apparatus statuses, the entity statuses and the node statuses. In some embodiments, the adjusting of, the generation of the electricity by the power generation facilities, the storage of the energy by the energy storage apparatuses, the generation of the electrical power by the energy storage apparatuses and the transmission of the electrical power by the electrical transmission nodes, is based on at least one of the predicted future electrical power demand and the predicted future electrical power generation capacity. In some embodiments, the adjusting of the generation of the electricity by the power generation facilities, the storage of the energy by the energy storage apparatuses, the generation of the electrical power by the energy storage apparatuses and the transmission of the electrical power by the electrical transmission nodes, comprises minimizing transmission distance to reduce electrical power loss. In some embodiments, the adjusting of the generation of the electricity by the power generation facilities, the storage of the energy by the energy storage apparatuses, the generation of the electrical power by the energy storage apparatuses and the transmission of the electrical power by the electrical transmission nodes, comprises prioritizing a subset of the one or more electrical consumption entities such that the subset receives power even when there is insufficient electrical power for all of the electrical consumption entities. In some embodiments, each of the facility statuses include one or more of whether the power generation facility is currently operational and a current electrical power generation capacity of the power generation facility. In some embodiments, each of the apparatus statuses include one or more of whether the energy storage apparatus is currently operational, a current quantity of stored energy of the energy storage apparatus and a current electrical power generation capacity of the energy storage apparatus. In some embodiments, the entity statuses include one or more of whether the electrical consumption entity is currently operational, a current electrical load of the electrical consumption entity, a current quantity of stored energy of the electrical consumption entity and a current electrical power demand of the electrical consumption entity. In some embodiments, the node statuses include one or more of whether the electrical transmission node is currently operational, a current electrical load of the electrical transmission node, a current quantity of stored energy of the electrical transmission node and a current electrical power demand of the electrical transmission node. In some embodiments, further comprising controlling each of the one or more power generation facilities with facility controllers, controlling each of the energy storage apparatuses with the apparatus controllers, controlling each of the one or more electrical transmission nodes with the node controllers and controlling each of the one or more electrical consumption entities with the entity controllers independent of commands received from the virtual power plant control center.

A third aspect is directed to a virtual power plant system. The system comprises a sensing and control network including one or more facility controllers, one or more apparatus controllers, one or more node controllers and one or more entity controllers, wherein each of the facility controllers sense a facility status of a power generation facility that generates electricity, each of the apparatus controllers sense an apparatus status of an energy storage apparatus that receives the electricity generated by the power generation facilities, each of the entity controllers sense an entity status of an electrical consumption entity, and each of the node controllers sense a node status of an electrical transmission node for receiving the electrical power from one of the apparatuses and transmitting the electrical power to one of the electrical consumption entities and a virtual power plant control center communicatively coupled with the sensing and control network for receiving the facility statuses, the apparatus statuses, the entity statuses and the node statuses, wherein the control center adjusts the generation of the electricity by the power generation facilities, the storage of the energy by the energy storage apparatuses, the generation of the electrical power by the energy storage apparatuses and the transmission of the electrical power by the electrical transmission nodes based on the facility statuses, the apparatus statuses, the entity statuses and the node statuses, wherein each of the energy storage apparatuses comprise a first fluid container for accommodating a liquid and a gas, a pump configured to pump the liquid into the first fluid container to compress the gas in the first fluid container using the electricity thereby storing energy and a hydrogenerator driven by the liquid coming out from the first fluid container to generate electrical power using the stored energy.

In some embodiments, the power generation facilities include one or more of a wind electric power generator, a water electric power generator, a solar electric power generator, and a heat electric power generator. In some embodiments, the electrical consumption entities include one or more of an industrial plant, a commercial center, and a residential area. In some embodiments, the electrical transmission nodes include one or more of a distribution transformer, an electrical substation, and an electrical transmission tower. In some embodiments, the virtual power plant control center utilizes artificial intelligence to predict future electrical power demand at one or more of the electrical consumption entities and future electrical power generation capacity at one or more of the power generation facilities and the energy storage apparatuses based on one or more of the facility statuses, the apparatus statuses, the entity statuses and the node statuses. In some embodiments, the virtual power plant control center adjusts the generation of the electricity by the power generation facilities, the storage of the energy by the energy storage apparatuses, the generation of the electrical power by the energy storage apparatuses and the transmission of the electrical power by the electrical transmission nodes based on at least one of the predicted future electrical power demand and the predicted future electrical power generation capacity. In some embodiments, when adjusting the generation of the electricity by the power generation facilities, the storage of the energy by the energy storage apparatuses, the generation of the electrical power by the energy storage apparatuses and the transmission of the electrical power by the electrical transmission nodes, the virtual power plant control center minimizes transmission distance to reduce electrical power loss. In some embodiments, when adjusting the generation of the electricity by the power generation facilities, the storage of the energy by the energy storage apparatuses, the generation of the electrical power by the energy storage apparatuses and the transmission of the electrical power by the electrical transmission nodes, the virtual power plant control center prioritizes a subset of the electrical consumption entities such that the subset receives power even when there is insufficient electrical power for all of the electrical consumption entities. In some embodiments, each of the facility statuses include one or more of whether the power generation facility is currently operational and a current electrical power generation capacity of the power generation facility. In some embodiments, each of the apparatus statuses include one or more of whether the energy storage apparatus is currently operational, a current quantity of stored energy of the energy storage apparatus and a current electrical power generation capacity of the energy storage apparatus. In some embodiments, the entity statuses include one or more of whether the electrical consumption entity is currently operational, a current electrical load of the electrical consumption entity, a current quantity of stored energy of the electrical consumption entity and a current electrical power demand of the electrical consumption entity. In some embodiments, the node statuses include one or more of whether the electrical transmission node is currently operational, a current electrical load of the electrical transmission node, a current quantity of stored energy of the electrical transmission node and a current electrical power demand of the electrical transmission node. In some embodiments, each of the facility controllers is able to control the power generation facility, each of the apparatus controllers is able to control the energy storage apparatus, each of the node controllers is able to control the electrical transmission node and each of the entity controllers is able to control the electrical consumption entity independent of commands received from the virtual power plant control center.

A computer-controlled energy storage system optimizes the process of energy storage and electricity re-generation. The computer-controlled energy storage system includes a computer instruction implemented (e.g., software) computing device, which can optimize the amount and/or pressure of the water pumped, the compressed air pressure range, the amount and/or pressure of the compressed air released, among other factors. The computer-controlled energy storage system can also use AI (artificial intelligence), ML (machine learning), BD (big data), robots (e.g., computer-controlled valves), VR (virtual reality), and AR (augmented reality) in optimizing the controlling systems.

In an energy storing state, the energy storage system is configured to pressurize/compress the gas (e.g., ambient air and nitrogen gas) to a first predetermined pressure level (e.g., 60 atm or 60 bar) forming a compressed gas for storing the energy. In an energy releasing state, the pressure of the compressed gas is reduced/released to a second predetermined pressure level (e.g., 40 atm or 20 atm) for energy release. In an energy storage and release cycle, the air is compressed and released in a pressure range that is optimized in terms of energy storage (energy storage and release) efficiency. In other words, the gas is not pressurized to an unneeded high-pressure level (e.g., 100 atm) and also does not release to an exhausted pressure level (e.g., 0 atm).

In some embodiments, the compressed air used herein is mainly used as a media, a force providing source, to push water to drive a hydroelectric generator. Thus, the mass, the velocity, the moving direction and the driving force generated by the injecting water or liquid are the factors affect the efficiency of driving the hydroelectric generator, whereas the compressed gas provides a spring-like forces to push/move the water or liquid.

In some embodiments, the energy storage system disclosed here does not rely on the heat generated when the air is compressed and does not rely on the compressed gas itself to drive the hydroelectric generator. Any other factors that are controllable by mechanical, chemical, or operational process and are able to be optimized in terms of energy storage/re-generation efficiency are within the scope of the Present disclosure.

The energy storage system uses a smart energy management system to compress the gas to a predetermined level to provide a controlled and optimized force for pushing and driving the water/liquid to drive the hydroelectric generator.

Other features and advantages of the present invention will become apparent after reviewing the detailed description of the embodiments set forth below.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates a power supplying system in accordance with some embodiments.

FIG. 2 illustrates a method of controlling and managing the energy storage efficiency in accordance with some embodiments.

FIG. 3 is a three-dimensional schematic diagram illustrates the energy storage system in accordance with some embodiments.

FIG. 4 is a three-dimensional schematic diagram illustrating the energy storage system in accordance with some embodiments.

FIG. 5 illustrates the energy storage system having n×m units of energy storages 10″.

FIG. 6 is a schematic flow chart showing the energy storage method using heterogeneous pressure media and interactive actuation in accordance with some embodiments.

FIG. 7 shows an electricity demand curve on a summer peak day.

FIG. 8 is a schematic flow chart illustrating the method of distributing electricity from an energy bank in accordance with some embodiments.

FIG. 9 illustrates a virtual power plant system according to some embodiments.

FIG. 10 illustrates a method of operating a virtual power plant system according to some embodiments.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

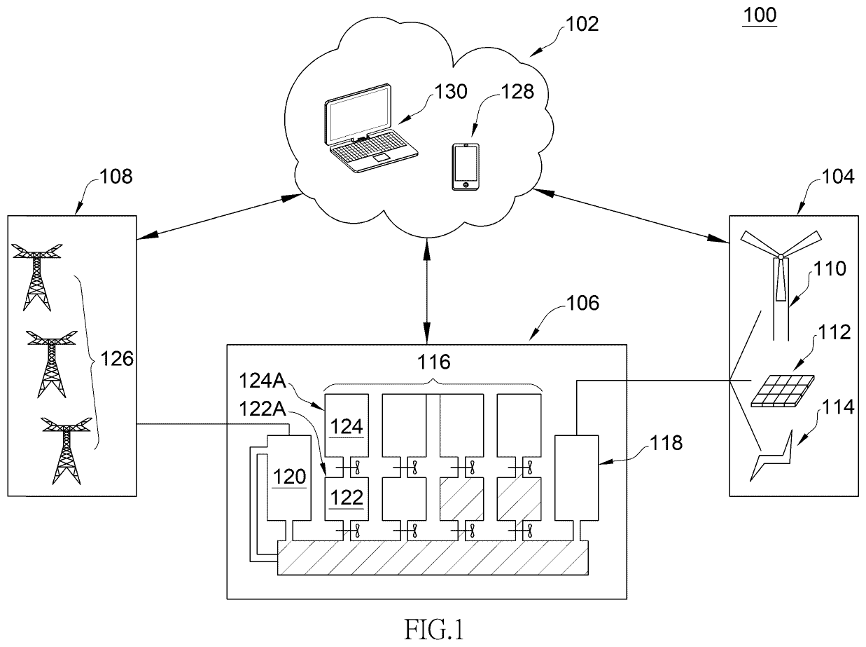

FIG. 1 illustrates a power supplying system 100 in accordance with some embodiments. The power supplying system 100 includes a control system 102, an energy generating system 104, an energy storage system 106, and an energy transmitting system 108.

In some embodiments, the control system 102 is configured to communicate/control the energy generating system 104, the energy storage system 106, and the energy transmitting system 108. In some embodiments, the control system 102 includes a computer instruction implemented (e.g., software) computing device, which can also use AI (artificial intelligence), ML (machine learning), BD (big data), robots (e.g., computer-controlled valves), VR (virtual reality), and AR (augmented reality) in assisting the optimization of the controlling operations. In some embodiments, the control system 102 comprises a computer server 130, a phone device 128 (e.g., smart phone), or any other electronic controlling devices that can be signally coupled with the systems and devices to be controlled (e.g., wirelessly or connected with wires).

In some embodiments, the energy generating system 104 has devices that generates electrical energy, including wind turbines 110, solar panels 112, and other forms of energy/electricity generating devices 114 (e.g., nuclear power plant, geothermal electricity generating plant, coal power plant, and renewable energy-based electricity generating plant.)

In some embodiments, the energy storage system 106 comprises one or more pumps 118, one or more vessels 116 (e.g., metal vessels (e.g., 8 mm-10 mm in thickness of steel plate) surrounded/encapsulated by concrete (e.g., 40 cm in its thickness), such as ferro-cement) and one or more generators 120. In some embodiments, the energy storage system 106 comprises one or more pumps 118, one or more concrete containers as the vessels 116 with a predetermined (e.g., 10 cm-100 cm) thickness. A person of ordinary skilled in the art appreciates that any other thickness are variable factors, which can be determined by safety and economic considerations.

The pumps 118 use energy received from the energy generating system 104 to pressurize one or more vessels 116 by pumping fluids (e.g., water 122) to compress the gas 124 forming a pressurized gas. The one or more vessels 116 can be pre-pressurized at a predetermined de-fault pressure, such as 10 atm-60 atm, 20 atm, 30 atm, 40 atm, 50 atm, or 90 atm. One liquid vessel 122A and one gas vessel 124A form a set or a unit of energy storage vessel set. In general, the one or more vessels 116 comprise from one unit to 100,000 units in one location (e.g., a power storage plant). Any numbers of units are within the scope of the present disclosure (e.g., 100,000,000 units). Each of the energy storage vessel set can be controlled and operated independently. In some embodiments, a predetermined numbers or zones of the energy storage vessel set can be controlled and operated together, concurrently, in sequence, or in any operational orders. The operation includes pressurizing, pumping fluids (e.g., liquid and gas), adjusting temperature, controlling rate of moving liquids or gases, and among any other controllable conditions. The one or more hydrogenerators 120 generate (e.g., re-generate) energy by using the water 122 to drive a hydrogenerator, wherein the water 122 is driven or pushed by releasing the pressured gas 124 (e.g., air, nitrogen or a mixture of two or more gases).

In some embodiments, the energy transmitting system 108 (e.g., electric power grid 126) transmits electricity to be used by users (e.g., residential uses and commercial uses).

In some embodiments, the energy storage system 106 is used as the energy storage device of the current power generation source (e.g., the energy generating systems 104). For example, the power generation source can be thermal power generation systems, hydroelectric power generation systems or a wind power generator, nuclear power, geothermal energy, tidal energy, etc. The power generation source generates electrical energy, and the electrical energy can further drive the pump 118 of the heterogeneous pressure media and interactive actuation energy storage system (e.g., the energy storage system 106) allowing the pump 118 to operate the working fluid to store energy in the energy storage 116. According to the power demand of the electrical energy (such as residential electricity, industrial electricity, etc.), the energy storage can be matched with or support the power generation source, or be the main alternative power source, supplying the electrical energy to the electrical energy demand through the electric power network at any time.

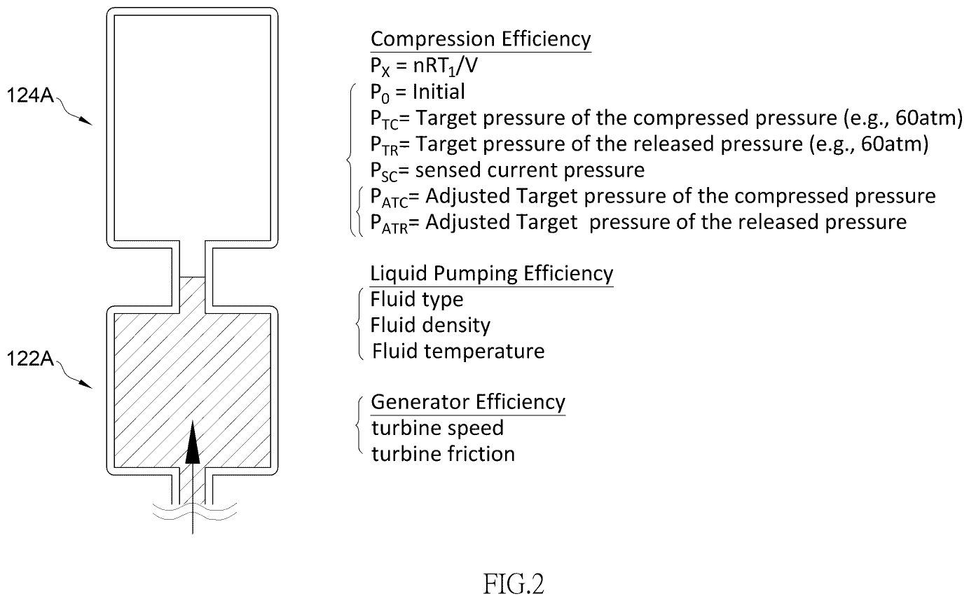

FIG. 2 illustrates a method 200 of controlling and managing the energy storage efficiency in accordance with some embodiments.

In some embodiments, the control system 102 (FIG. 1) is configured to communicate/control the energy storage system 106 (FIG. 1), which optimizes the energy storage and re-generating efficiency. For example, the control system 102 (FIG. 1) receives sensed system conditions and environmental conditions (e.g., via one or more sensors coupled with the energy storage system) and use such received information to calculate and control the energy storage system 106 (FIG. 1), so that the energy storage system 106 is operated at an optimized efficiency. The efficiency can include total energy store-and-release efficiency (e.g., energy conversion rate, such as maintaining at least 65% or 70% or above efficiency), generating most economic value (e.g., compress and release the water and gas at a speed or manner that generates most dollar profits, generating the least heat, generating the most heat, causing the least equipment damages, optimized matching efficiency of the rotational speed of the hydrogenerator with driving fluid (e.g., liquid or gas) or any other efficiencies.

In some embodiments, the control system 102 (FIG. 1) is configured to operate the energy storage system 106 (FIG. 1) to repeatedly pressurized and de-pressurized in a predetermined pressure range similar to release 20% of a compressed spring and then compress again to compress back the released 20% of the spring. The energy storage system does not pressurize the air to a very high pressure, which cause significant energy lost among other issues. In contrast, in some embodiments, the compressed air of the Present energy storage system is pressurized to around 60 bar/atm only. The compressed air, in fact, is acting more like a mechanical spring providing a force pushing the water to drive the hydro-generator. So the energy storage system discloses herein can be more like a piston in a combustion engine, where the water is more like the piston and a change of the air pressure is used to push or pull the piston (e.g., causing a repeating back-and-force motion). In other words, there is a delicate balance in terms of the ideal pressure range vs. energy storage efficiency.

In some embodiments, the control system 102 (FIG. 1) is configured to monitor and operate the energy storage system 106 (FIG. 1) based on the following efficiency factors including compression efficiency, liquid pumping efficiency, generator efficiency or a combination therefore (e.g., the total efficiency of the system).

In some embodiments, the total efficiency of the system can be the total energy store-and-release (or regenerate) efficiency, which can be operated using the formula fₓ (Pₓ)=nRT/V, wherein P is the pressure, x is the status of the selected time, n is the molar number of gas to be compressed, R is a predetermined constant or an ideal gas constant, and T is the temperature. Artificial intelligence or machine learning are used based on the formula provided above or any other formula to monitor and optimize the efficiency of the energy storage system.

The above formula can be rewritten into V_{(air, t)}=nRT/P. Since the total volume (Vₜₒₜₐₗ) of the total space of the vessels minus the volume occupied by the air V_{(air, t)} equal to the volume of the water V_{(water, t)}, the amount of energy stored can be shown as V_{(water, t)}=Vₜₒₜₐₗ−V_{(air, t)}. Thus, V_{(water, t)} can be used as a control factor for how much energy is stored or to be stored at the specific time₍ₜ₎.

In an example, the control system 102 sets an initial pressure P₀ at time zero, which is the starting point of compression. P_{TC} is a Target Pressure of the Compressed Pressure (e.g., 60 atm), P_{TR} is a Target Pressure of the Released Pressure (e.g., 40 atm), P_{SC} is a Sensed Current Pressure (e.g., 10 atm at 1 hr mark of the compression process). The implemented software calculated and proposed an operational model makes the energy storage perform with an optimized efficiency. During the gas compression process, the targeted pressure of the compressed and release pressure are adjusted based on the sensed conditions, such as the changes of the sensed temperatures, changes of the electricity costs, among other factors. Thus, the control system 102 provides P_{ATC} which is an Adjusted Target Pressure of the Compressed Pressure (e.g., 58.6 atm), P_{ATR} which is an Adjusted Target Pressure of the Released Pressure (e.g., 38.2 atm).

In some embodiments, the control system 102 monitors and controls the air compression to generate a small amount of heat, which is sufficient to be used to provide heat to the gas when it is expanded subsequently. The heat can be stored first and then subsequently transferred to be used. The above operation can be based on the equation P₂V₂/P₁V₁=T₂/T₁, wherein 1 indicates a first condition/status (e.g., before gas compression) and 2 indicates a second condition/status (e.g., after gas compression). In some cases, since the gas to be compressed is from 40 atm to 60 atm, (60−40)/40=0.5 times of the original pressure is the pressure change amount. Such heat generated during compression can be insignificant.

In some embodiments, the liquid pumping efficiency to be monitored and optimized includes pump type, pump operational efficiency, and among other factors.

In some embodiments, the generator efficiency to be monitored and optimized includes turbine speed, turbine friction, and liquid speed & amount to energy generating ratio, and among other factors.

In some embodiments, the air compression is controlled by an AI model. The system modified the model based on the prior operational efficiency to adjust the AI model so that the control factors are optimized based on various environmental conditions, such as temperature of the weather, temperature of the water pumped in, temperature of the tank, temperature of the encapsulating concrete, among other factors.

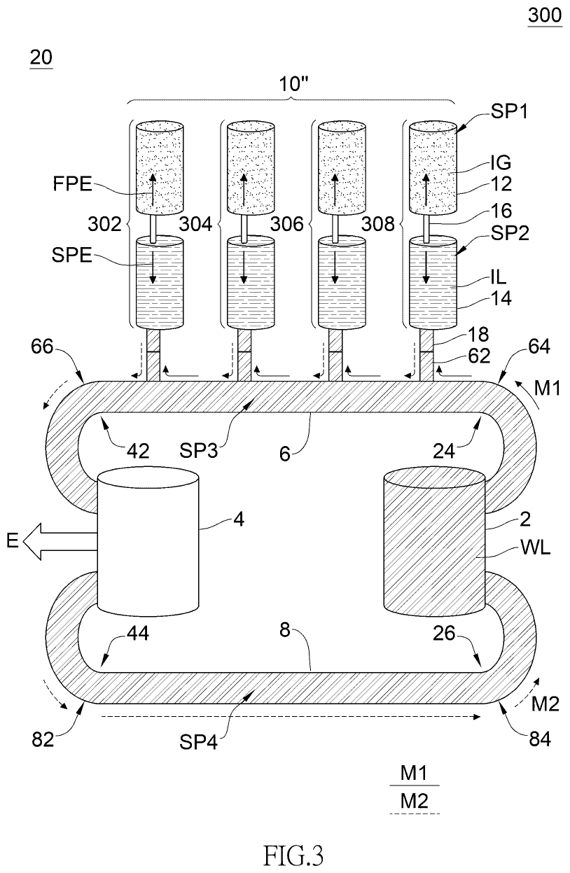

FIG. 3 is a three-dimensional schematic diagram 300 illustrates the energy storage system 106 (FIG. 1) in accordance with some embodiments. In the FIG. 3, a heterogeneous pressure media and interactive actuation energy storage system 20 includes a plurality of energy storages 10″ (e.g., similar to the energy storage 116 of FIG. 1), a liquid source 2, a converter 4 (e.g., hydrogenator), a first pipe 6 and a second pipe 8. Here, the energy storage 10″, the liquid source 2, the converter 4, the first pipe 6 and the second pipe 8 forming a closed and circulating energy storage and release structure according to the flow path of the working fluid WL.

Here, the energy storages 302, 304, 306 and 308 are illustrated by 4 units as an example. In other embodiments, the number can be arbitrarily selected, for example, the range of the number may be between 10 and 100 energy storages 10″, 100 and 1,000 energy storages 10″, or 1,000 and 999,999 energy storages 10″. Here, the energy storages 302, 304, 306 and 308 respectively accommodate a fluid (e.g., liquid, gas, or a combination thereof) and respectively include a first set of containers 12, a second set of containers 14, a first set of tubes 16 and a second set of tubes 18. In addition, in some embodiments, the energy storages 302, 304, 306 and 308 may be added to or removed from the heterogeneous pressure media and interactive actuation energy storage system 20 in real-time or on-demand. Or, the energy storages 302, 304, 306 and 308 may be controlled through the valve body to determine whether to operate (deemed as added) or not to operate (deemed as removed) in the energy storage system 20.

The first set of containers 12 forms a first set of spaces SP1 to store an initial gas IG (e.g., air or helium) in each of the first set of containers 12.

The second set of containers 14 are disposed of on the lower side of the first set of containers 12, and the second set of containers 14 form a second space SP2 to store an initial liquid IL (e.g., water) in each of the second set of containers 14.

One end of the first tube 16 is coupled to the first container 12 and the other end of the first tube 16 is coupled to the second container 14, so that the first tube 16 connects with the first space SP1 and the second space SP2.

One end of the second tube 18 is coupled to the second container 14 and the other end of the second tube 18 is coupled to the first pipe 6. Wherein, the diameter of the second tube 18 may be larger or smaller than the diameter of the first tube 16.

The liquid source 2 supplies and recycles the working liquid WL. For example, the liquid source 2 may be a reservoir, a water tower, a reservoir, and the like. Wherein, the function of the liquid source 2 functioning as a supply can be referred to as the description of the prior embodiment, which will not be repeated here. Here, in addition to the function of supply, the liquid source 2 can also recycle the working fluid WL outputted by the converter 4 through the second pipe 8.

The converter 4 receives and outputs the working fluid WL (e.g., dual functions of a liquid pump and a hydro generator). For example, the converter 4 may be a liquid pump, a turbo pump, a liquid generator, a liquid turbine generator, a hydro turbine generator, or other liquid driven device configured to generate electricity. When the converter 4 functions as a supply, reference may be made to the description of the prior embodiment, which will not be repeated here. Here, in addition to the function of supplying, the liquid source 2 can also recycle the working liquid WL outputted from the converter 4 through the second pipe 8.

The first pipe 6 forms a third space SP3, and the first pipe 6 has a plurality of connection ports 62, a first connection point 64, and a third connection point 66. Each of the connection ports 62 connects each of the second spaces SP2 and each of the third spaces SP3. In addition, the first connection point 64 and the third connection point 66 are formed at the two ends of the first pipe 6. The first connection point 64 is coupled to the first end 24 of the liquid source 2 and the third connection point 66 is coupled to the first end 42 of the converter 4.

The second pipe 8 forms a fourth space SP4, and a first end 82 of the second pipe 8 is coupled to a second end 44 of the converter 4 and a second end 84 of the second pipe 8 is coupled to the second end 26 of the liquid source 2.

In the first operation mode M1 (e.g., energy storing mode), the working liquid WL from the liquid source 2 is injected into the second space SP2 through the first pipe 6 and the second tube 18, so that the working liquid WL drives the initial liquid IL through the first tube 16 to continuously compresses the initial gas IG in the first space SP1 until the initial gas IG acting on the first space SP1 has a predetermined pressure, thereby enabling the first container 12 to store a first pressure energy FPE.

In the second operation mode M2 (e.g., energy releasing mode), the initial gas IG continuously expands due to its pressure by opening a controlling valve to drive the initial liquid IL moving toward and discharge from the second tube 18 to convert the first pressure energy FPE into a second pressure energy SPE and pass through the first pipe 6 to drive the converter 4 to generate an electrical energy E; and the working liquid WL after driving the converter 4 returns to the liquid source 2 through the second pipe 8.

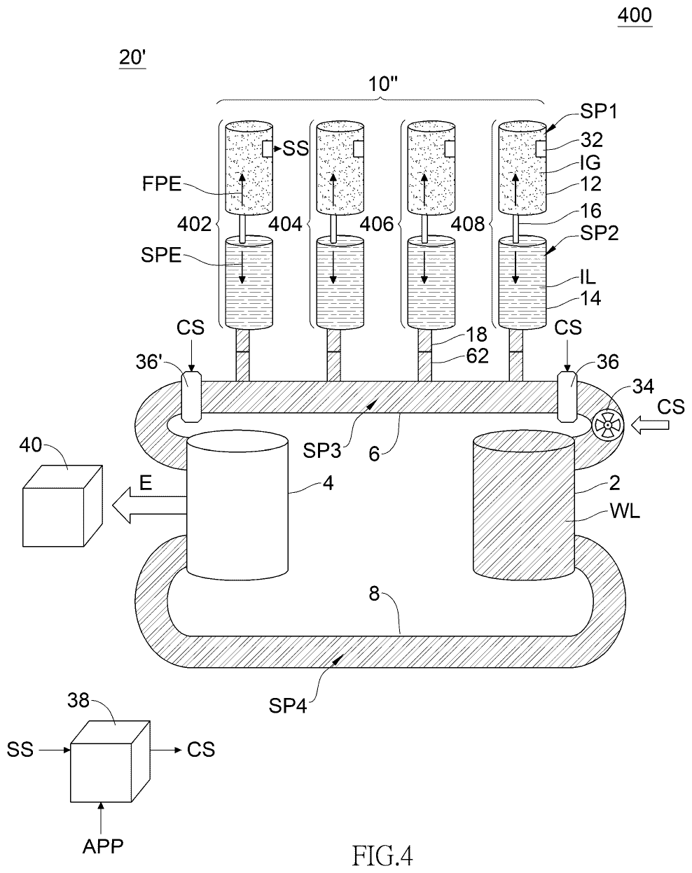

FIG. 4 is a three-dimensional schematic diagram 400 illustrating the energy storage system in accordance with some embodiments. In FIG. 4, the energy storage system 20′ includes not only the energy storage 10″, the liquid source 2, the converter 4, the first pipe 6 and the second pipe 8, but also a pressure sensor 32, a pump 34, a valve body 36, and a controller 38. The pump 34 enables the heterogeneous pressure media and interactive actuation energy storage system to have a better energy storage effect, storing and releasing more energy.

The description of the energy storage 10″, the liquid source 2, the converter 4, the first pipe 6 and the second pipe 8 are the same as the description of the earlier embodiment and will not be repeated here.

The pressure sensor 32 can be used to sense, for example, changes in the working fluid WL, the initial liquid IL or the initial gas IG and generate a corresponding sensing signal SS. Here, the pressure sensor 32 is disposed of at the first container 12 as an example. In other embodiments, the pressure sensor 32 may also be disposed of at least one of the second container 14, the first tube 16, the second tube 18, the first pipe 6 and the second pipe 8.

The pump 34 can be used to adjust, for example, the flow rate of the working liquid WL or the initial liquid IL. The pump 34 herein can be specially designed to provide the working liquid WL to generate a higher flow rate and pressure to act on the initial liquid IL and the initial gas IG, and energy can be quickly and readily stored in the first container 12 and the second container 14. Herein, the pump 34 is disposed between the first pipe 6 and the liquid source 2 as an example. In other embodiments, the pump 34 may also be disposed of at least one of the first space SP1, the second space SP2, the first tube 16, the second tube 18, between the first tube 16 and the first container 12, between the second tube 18 and the second container 14, the first pipe 6, the second pipe 8, between the second pipe 8 and the liquid source 2, and between the second pipe 8 and the converter 2. In addition, the pump 34 regulates the working liquid WL of the liquid source 2 to enter the energy storage 10″.

The valve bodies 36, 36′ can provide an open mode and a closed mode manually and automatically. The automatic control can be done via the control signal CS. The control signal CS can be generated from the controller 38. Moreover, in the open mode, the working fluid WL, the initial liquid IL and the initial gas IG can pass through the valve bodies. In the closed mode, the working fluid WL, the initial liquid IL and the initial gas IG are stopped by the valve bodies. Herein, taking the valve body 36 between the first pipe 6 and the liquid source 2 and the valve body 36′ between the first pipe 6 and the converter 4 as an example for description, in other embodiments, the valve body may also be disposed at the at least one of the first container 12, the second container 14, the first tube 16, the second tube 18, between the first tube 16 and the first container 12, between the second tube 18 and the second container 14, the first pipe 6, the second pipe 8, between the second pipe 8 and the liquid source 2, and between the second pipe 8 and the converter 4.

The controller 38 may receive a sensing signal SS generated by the pressure sensor 32 from sensing the pressure generated by, for example, the working fluid WL, the initial liquid IL or the initial gas IG. The controller 38 generates a control signal CS according to the sensing signal SS to operate the valve bodies 36, 36′ to further execute the open mode or the closed mode. In detail, the controller 38 outputs the control signal CS to operate the valve body 36 to control the initial gas IG at a predetermined pressure, and when the initial gas IG has a predetermined pressure, the initial gas IG stops to be compressed.

In another embodiment, the controller 38 can control the control program APP (e.g., similar to control system 102 of FIG. 1) to allow the energy storages 402, 404, 406 and 408 to store the first pressure energy FPE or convert the second pressure in a synchronous manner. For example, the controller 38 controls the valve body 36 so that the four energy storages 402, 404, 406 and 408 can simultaneously store about four times the first pressure energy FPE, or the four energy storages 402, 404, 406 and 408 can simultaneously release about four times the second pressure energy SPE. In some embodiments, the controller commands that the four energy storages 402, 404, 406 and 408 simultaneously store the first pressure energy (FPE) during off-peak periods. In some embodiments, the controller commands that the four energy storages 402, 404, 406 and 408 simultaneously release the second pressure energy (SPE) during peak periods.

In yet another embodiment, the controller 38 can also control a control program APP to allow the energy storages 402, 404, 406 and 408 to store the first pressure energy FPE or convert the second pressure energy SPE asynchronously. For example, the controller 38 controls the valve body 36 or individually controllable valves at connection ports 62 (not shown) so that any of the energy storages 402, 404, 406 and 408 can independently store or release energy. In other words, the controller 38 can select one, more or all of the energy storages to drive the converter to generate one or several times the electrical energy or extend the duration for the electrical energy E to generate electricity.

In some embodiments, the first pressure energy FPE stored in the energy storages 402, 404, 406 and 408 is different from each other to maximize the total energy storage efficiency of the energy storage system. For example, compared to the energy storages 404, 406 and 408, the energy storage 402 can store the minimum first pressure energy. If the first pressure energy stored in the energy storage 402 is sufficient to cover the difference between the energy required by the market and the energy currently available, the energy storage system may not need to release the FPE stored in the energy storages 404, 406 and 408. In this way, over-operation of the energy storage system can be avoided.

In another embodiment, the controller 38 monitor the amount of electrical energy E generated. For example, when an abnormality (such as insufficiency or overload) occurs in the electric power, the controller 38 issues an abnormal notification.

In another embodiment, the controller 38 is capable of configuring electrical energy E, so as to supply electrical energy required in the energy storage 10 to achieve the purpose of self-generation and self-supply.

In another embodiment, the energy storage 10 further includes an extended energy storage unit 40 connected to the converter 4 to store electrical energy E. The extended energy storage unit 40 may be, for example, a storage battery, a secondary battery, a supercapacitor, or the like.

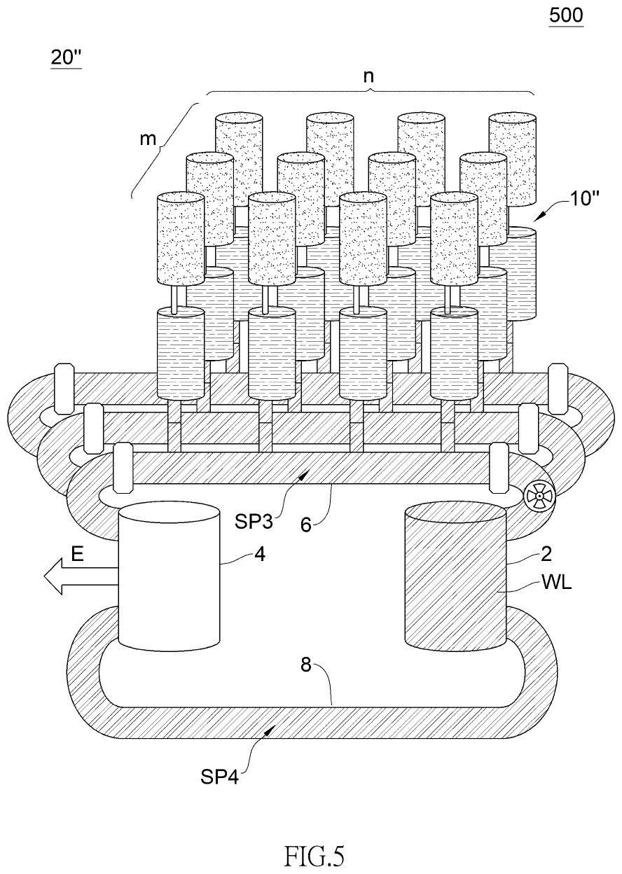

FIG. 5 illustrates the energy storage system 500 having n×m units of energy storages 10″. In this embodiment, the energy storage system 500 has 4×3 units of energy storages 10″. The number of energy storages 10″ can be adjusted according to the needs of the user. In some embodiments, the energy storage system 500 has 200×300 units of energy storages 10″.

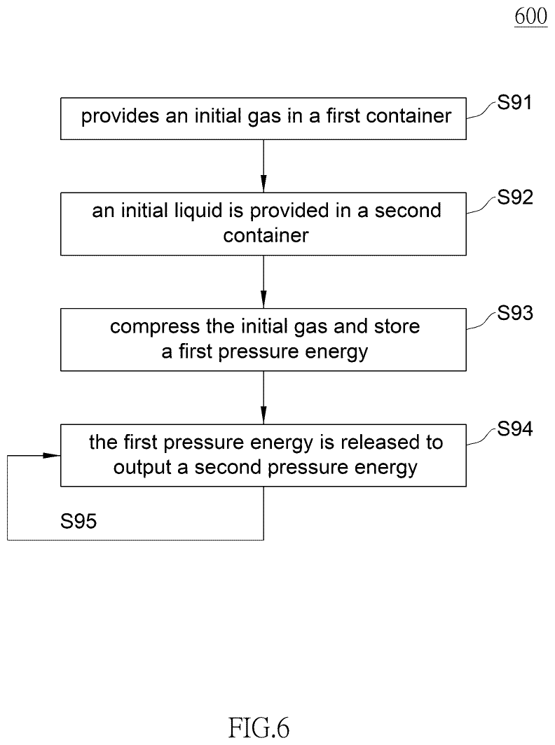

FIG. 6 is a schematic flow chart 600 shows the energy storage method using heterogeneous pressure media and interactive actuation in accordance with some embodiments. In FIG. 6, the method starts at Step S91, which provides an initial gas in a first container. The initial gas can be air or inert gas (e.g., helium, nitrogen).

At Step S92, an initial liquid (e.g., water) is provided in a second container.

At Step S93, a working liquid is supplied to the second container to drive the initial liquid to compress the initial gas and store a first pressure energy. In some embodiments, the working liquid is the same as the initial liquid (e.g. water). The predetermined ranges of pressure, speed, among others of compression and release are monitors and controlled by appropriate sensors and controllers (e.g., computer-controlled valves).

At Step S94, the first pressure energy is released by expanding the compressed gas to drive the initial liquid to work on the working fluid to output a second pressure energy.

At Step S95, Steps S93 to S94 are performed to repeatedly act between the first pressure energy and the second pressure energy to output energy; for example, using the second pressure energy to drive a converter (such as a liquid pump, a turbo pump, liquid generator, liquid turbine generator, hydro turbine generator) to generate electricity.

In another embodiment, after Step S95, the working fluid is recovered to be applied to the second container again to form a closed system in which the working fluid can be repeatedly used.

In utilization, the devices and systems are used to store and release energy so that such stored energy can be used on-demand.

In operation, a system converts an electrical energy into a potential energy or compressed air energy, storing the converted energy, and releasing the stored energy when in-demand.

The power storage system can be used as a backup power system or standby power system, which can be built in supporting a power plant or a sub-power plant (e.g., at the power distribution level before the end user). For example, the power storage system can be used when the supply of the green energy/electrical power is disrupted or unstable.

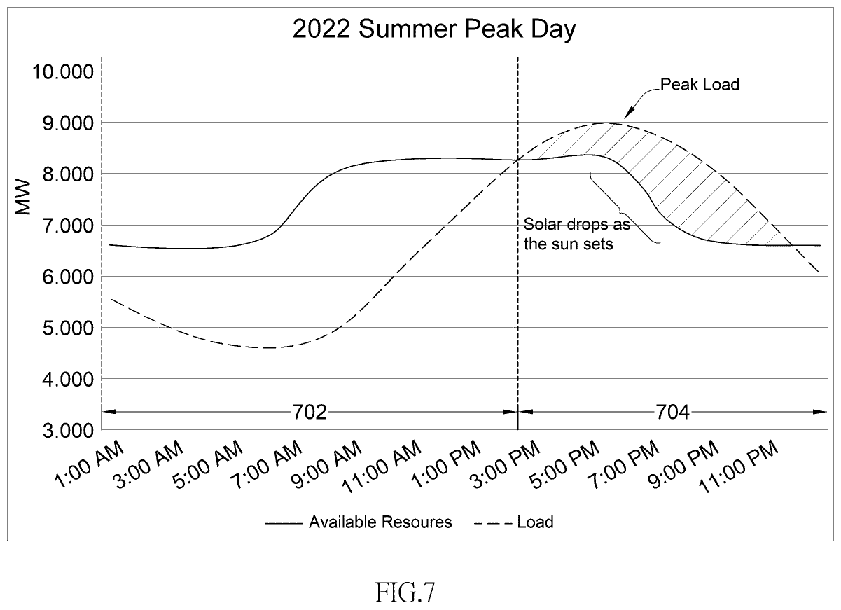

FIG. 7 shows an electricity demand curve on a summer peak day. In FIG. 7, zone 702 is in the period of excess power supply and zone 704 is in the period of power supply deficit. For more efficient use of electricity, the energy storage system of this disclosure can be in an energy storage mode during the period of excess power supply and in electricity generating mode during the period of electricity shortage.

The energy storage efficiency of the energy storage system can be optimized based on an efficiency factor, such as total economic efficiency. In FIG. 7, the electricity price for zone 702 is an off-peak electricity price and the electricity price for zone 704 is a peak electricity price. As mentioned above, in FIG. 4, the pump 34 can be used to adjust the flow rate of the working liquid WL or the initial liquid IL.

During the off-peak periods (zone 702) shown in FIG. 7, the pump 34 can be arranged to provide the working liquid WL to generate a higher flow rate and pressure to act on the initial liquid TL and the initial gas IG, and energy can be quickly and easily stored in the first container 12 and the second container 14.

During the peak periods (zone 704) shown in FIG. 7, the energy stored in a form of the amount of water, which can be pushed to drive a hydrogenerator by the compressed gas so that electricity is generated/regenerated on-demand.

FIG. 7 illustrates that the energy can be stored and re-generated based on a extra supply-and-on demand relationship. The energy storage system disclosed herein can operate based on any other determining factors, such as the market price of the energy during the time in a day/season/in-real time, electricity demands in a city, regional supply or demand, and among any other factors.

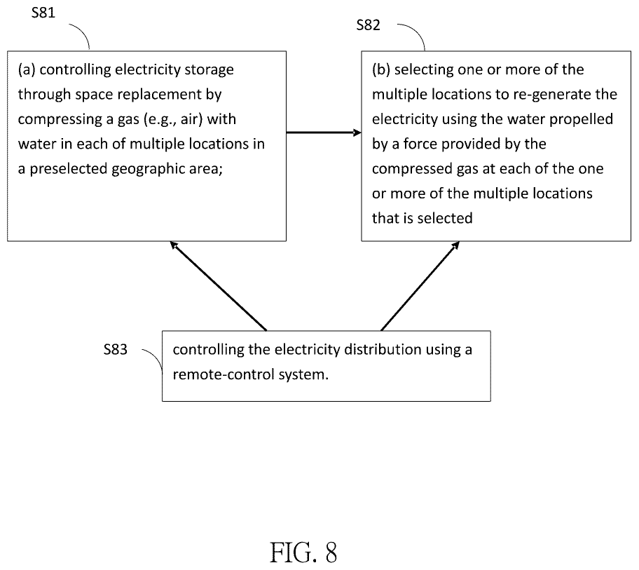

FIG. 8 is a schematic flow chart illustrating the method of distributing electricity from an energy bank in accordance with some embodiments. In FIG. 8, the method starts at Step S81. At Step S81, the electricity storage is controlled through space replacement by compressing a gas (e.g., air) with water in each of multiple locations in a preselected geographic area.

At Step 82, one or more of the multiple locations is selected to re-generate the electricity using the water propelled by a force provided by the compressed gas at each of the one or more of the multiple selected locations.

At Step 83, the electricity distribution is controlled by a remote-control system. For example, the electricity distribution can be controlled by a mobile device such as a smart phone. The switch between electricity storage and regeneration can be determined by the electricity price, such as the market electricity purchasing price, the market electricity selling price. The switch between electricity storage and regeneration can also be determined by electricity demand.

In utilization, the energy storage systems are used for energy storage.

In operation, energy is stored in a form of water with compressed gas and energy can be released or re-generated in a form of electricity when needed, which is controlled by the operating systems disclosed herein.

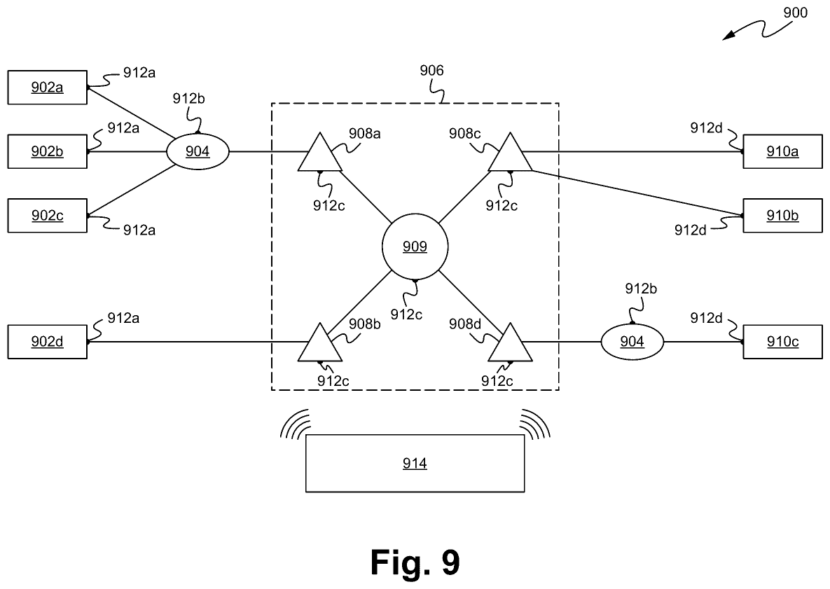

FIG. 9 illustrates a virtual power plant control system 900 in accordance with some embodiments. The virtual power plant control system 900 is substantially similar to the system 100 except for the differences described herein. As shown in FIG. 9, the system 900 comprises one or more power generation facilities 902a-d, one or more power storage apparatuses 904, an electrical power transmission network 906 (including one or more step-down or step-up substations 908a-d and/or one or more power lines/towers 910), one or more power consuming entities 910a-c and a virtual power plant control center 914. Although as shown in FIG. 9, the system 900 comprises four generation facilities 902a-d, two storage apparatuses 904, four substations 908a-d, one set of power lines/towers 909, three power consuming entities 910a-c and one control center 914, more or less generation facilities 902a-d, storage apparatuses 904, substations 908a-d, power lines/towers 909, power consuming entities 910a-c and/or control centers 914 are contemplated. Additionally, as shown in FIG. 9, each of the power generation facilities 902a-d are able to have a facility controller/sensor 912a, each of the power storage apparatuses 904 are able to have an apparatus controller/sensor 912b, each of the nodes of the transmission network 906 (e.g. the step-down or step-up substations 908a-d and/or the power lines/towers 909) are able to have a node controller/sensor 912c, and each of the power consuming entities 910a-c are able to have an entity controller/sensor 912d. Alternatively, one or more of the controllers/sensors 912a-d are able to be omitted. The sensors 912a-d are able to comprise smart sensing devices and/or other types of computing devices (e.g. including memory storing executable instructions and measured/calculated data, processors, network interfaces, various types of sensors for measuring electrical power output/frequency/load/other values, and/or other computing device components well known in the art).

The generation facilities 902a-d generate electrical power. For example, the generation facilities 902a-d are able to comprise wind turbines, solar panels, tidal generators and other forms of energy/electricity generating devices (e.g., nuclear power plant, geothermal electricity generating plant, coal power plant, and renewable energy-based electricity generating plant). As shown in FIG. 9, the generation facilities 902a-d are electrically coupled with the transmission network 906 either directly (e.g. 902d) or indirectly via one or more of the power storage apparatuses 904 (e.g. 902a-c). As a result, the generation facilities 902a-c are able to provide electrical power (e.g. electricity) to the storage apparatuses 904 or directly to the transmission network 906.

The storage apparatuses 904 are able to be substantially similar to the energy storage system 106 or other energy storage apparatuses such that they are each able to electrically couple with and receive electricity from one or more of the energy generation facilities 902a-d, store the energy for a period of time (e.g. via pressurized air), and then regenerate and output the electrical energy when desired. As shown in FIG. 9, the storage apparatuses 904 are able to be coupled between the generation facilities 902a-d and the transmission network 906 and/or between the transmission network 906 and the power consuming entities 910a-c for receiving electrical power (from the facilities 902a-d and/or the network 906), storing some or all of the electrical power for a period of time, and outputting regenerated electrical power (e.g. electricity) to the transmission network 906 and/or the power consuming entities 910a-c.

The transmission network 906 is electrically coupled with and able to receive electrical power from the generation facilities 902a-d and/or the power storage apparatuses 904 and transmit the electrical power to one or more of the power consuming entities 910a-c and/or one or more of the power storage apparatuses 904. The substations 908a-d are able to either step-up (e.g. 908a, b) the received electricity to a higher voltage (that is more efficient to transmit over long distances) or step-down (e.g. 908c, d) the received electricity to a lower voltage (that is useable by the power consuming entities 910a-c). The power lines/towers 909 are able to route the electricity to the desired destination (e.g. substation 908, power consuming entity 910, power storage apparatus 904).

The power consuming entities 910a-c are electrically coupled with and receive electricity from the transmission network 906 and/or the power storage apparatuses 904. The power consuming entities 910a-c are able to comprise one or more of an industrial entity or entities (e.g. factory), a commercial entity or entities (e.g. a shopping mall), and a residential entity (e.g. one or more residential houses/whole communities).

The controllers/sensors 912a-d are able to monitor and/or control the operations of the associated component of the system 900. Specifically, in real-time, the controllers/sensors 912a-d are each able to monitor characteristics/parameters of the associated component of the system 100 (e.g. facility, apparatus, node, entity) such as a current generation capacity, an operational status, current energy storage levels, current local loads. For example, the facility controllers/sensors 912a are able to sense an operational status (e.g. non-operational; operational) of the facility 902a-d that they are associated with as well as sense information about the operation of the facility 902a-d such as current power output levels, maximum output capacity, etc.; the apparatus controllers/sensors 912b are able to sense an operational status (e.g. non-operational; operational) of the apparatus 904 that they are associated with as well as sense information about the operation of the apparatus 904 such as current stored power levels, current power intake levels, current power output levels, maximum output capacity, maximum input capacity, maximum storage capacity, etc.; the node controllers/sensors 912c are able to sense an operational status (e.g. non-operational; operational) of the node 908, 909 that they are associated with as well as sense information about the operation of the node 908, 909 such as current voltage step-up or step-down level, current power input rate, current power output rate, maximum throughput, etc.; and/or the entity controllers/sensors 912d are able to sense an operational status (e.g. non-operational; operational) of the entity 910a-c that they are associated with as well as sense information about the operation of the entity 910a-c such as current load/power needs; minimum load/power needs; maximum load/power needs, current power input rate, etc.

The controllers/sensors 912a-d are able to be wired or wirelessly coupled with the virtual power plant control center 914. For example, the coupling is able to be effectuated via Internet of Things (IoT) networks, wireless communication networks, and/or dedicated power line communication (PLC) to transmit data from each controller/sensor 912a-d to the control center 914 and/or to each other and vice versa. In some embodiments, the one or more of the controllers/sensors 912a-d and/or the control center 914 are able to comprise a computer server or set of servers, a computing device or set of devices, a phone device (e.g., smart phone), or any other electronic controlling devices that can be signally coupled with the systems and devices to be controlled (e.g., wirelessly or connected with wires).

The virtual power plant control center 914 is able to receive data from and send data to the controllers/sensors 912a-d. Specifically, the control center 914 is able to receive and analyze data about the system 900 (collected by the controllers/sensors 912a-d) and then control the operation of one or more components of the system 900 based on the data. Thus, the control center 914 is able to control the rate, frequency, and/or other parameters of the electrical power output by the power generation facilities 902a-d (e.g. based on the past, current and/or predicted power demand by the consuming entities 910a-c). Similarly, the control center 914 is able to control the rate, frequency, and/or other parameters of the energy stored by and/or the electrical power output by the power storage apparatuses 904 (e.g. based on the past, current and/or predicted power demand by the consuming entities 910a-c, and/or based on the past, current and/or predicted power output by the power generating facilities 902a-d).

In other words, in some embodiments in operation, each of the controllers/sensors 912a-d continuously monitors, analyzes and/or reports operational and other data to the control center 914 and/or other controllers/sensors 912a-d. The control center 914 is able to consolidate the data from one or more of the controllers/sensors 912a-d about the distributed energy sources (e.g. 902a-d, 904), distributed energy consumers (e.g. 910a-c), and the load on the distributed transmission network 906 to create a global energy map. Based on this data and/or map, the control center 914 is able to issue control commands to one or more of the controllers/sensors 912a-d for controlling the associated component of the system 900 such that individual components adjust their output/input/operation accordingly (e.g., modifying generation output, activating standby generators, adjusting loads). Additionally, the control center 914 and/or the controllers/sensors 912a-d continuously monitor operational performance and adjust scheduling deviations in real-time to maintain overall load balance of the system 900.

As a result, the system 900 is able to provide distributed renewable energy source scheduling by balancing fluctuations in wind and solar power generation as well as provide emergency peak shaving by activating backup storage systems (e.g. 904) and/or deploy large-scale distributed energy resources (DERs) during peak demand or equipment failures to ensure stable power supply. Further, the system is able to aggregate small-scale resources to participate in electricity markets, providing frequency regulation and voltage support, achieving both economic benefits and improved system stability.

In some embodiments, one or more of the controllers/sensors 912a-d and/or the control center 914 are able to comprise artificial intelligence (AI) and/or other forms of machine learning in order to control the associated component of the system 900 and/or the entire system 900 (in the case of the control center 914). For example, one or more of the controllers/sensors 912a-d and/or the control center 914 are able to comprise a computer instruction implemented (e.g., software) computing device, which can also use AI (artificial intelligence), ML (machine learning), BD (big data), robots (e.g., computer-controlled valves), VR (virtual reality), and AR (augmented reality) in assisting the optimization of the controlling operations. Specifically, in some embodiments, one or more of the controllers/sensors 912a-d and/or the control center 914 are able to forecast/predict future characteristics/parameters of the associated component of the system 100 (e.g. facility, apparatus, node, entity) or multiple components of the system 900 (in the case of the control center 914) such as predicted future generation capacity, predicted future operational status, predicted future energy storage levels, predicted future local loads (e.g. entity electrical power needs/values). In other words, the controllers/sensors 912a-d and/or the control center 914 are able to predict (e.g. short-term) power demand and/or renewable energy fluctuations (e.g. less energy production at night, when cloudy, when not windy, etc.), thereby enabling proactive generating, storing and transmitting of electrical energy based on the predicted power demand and/or renewable energy fluctuations (and/or other insights).

Additionally, in such embodiments one or more of the controllers/sensors 912a-d and/or the control center 914 are able to control the associated component of the system 100 (e.g. facility, apparatus, node, entity) or multiple components of the system 900 (in the case of the control center 914) based on the predicted future characteristics/parameters. For example, the one or more of the controllers/sensors 912a-d and/or the control center 914 are able to: control when (e.g. frequency, duration, time) and how much power one or more of the generation facilities 902a-d and/or power storage apparatuses 904 produce; where (e.g. to/through which entities 910, apparatuses 904, substations 908 and/or towers 909), when and how much power is routed through the transmission network 906 (e.g. such that certain destinations are able to be prioritized over others); when and how much power to store within one or more of the apparatuses 904; and any of the other operations/functions of one or more of the components of the system 900 described herein. Thus, in such embodiments the one or more of the controllers/sensors 912a-d and/or the control center 914 provide the benefit of enabling the virtual power plant system 900 to monitor, control, and predict the distribution and usage efficiency—(power generation, storage, transmission, consumption), and thus to (1) maximize the power usage efficiency (2) reduce power loss (e.g., transmission distance), and (3) provide priority of uses (e.g. important components of the system 900 (e.g., hospitals, important customers, important nodes etc.) are giving higher priority for receiving power at times when power is limited).

Alternatively or in addition, in some embodiments one or more of the controller/sensors 912a-d are able to operate independently of commands received from the control center 914. In such embodiments, the individual controllers/sensors 912a-d are able to analyze sensed data about the associated component of the system 900 and control that component based on the sensed/analyzed data (e.g. based on predictions derived therefrom). Like described above, this local controller/sensor 912a-d controlling of the component is able to control how much power is generated, stored, output, consumed, transmitted and/or any of the other functions described above. Further, similar to above, this local controlling is able to be based on AI and/or other machine learning programming stored and operating locally on the controller/sensor 912a-d.

In some embodiments, one or more of the controllers/sensors 912a-d send the sensed data to the control center 914 for analysis. Alternatively, one or more of the controllers/sensors 912a-d locally analyze the sensed data (as described herein) and only transmit the results (or a subset of the results) of the analysis to the control center 914. For example, the subset of the results is able to be data/analysis that relates to overall system performance such that the control center 914 is better suited to control the system based on the subset (e.g. data that indicates a problem with upstream or downstream power generation, transmission and/or storage that cannot be controlled by the local controller/sensor 912a-d and/or its associated component of the system 900).

In some embodiments, core controlling strategy of each of the controllers/sensors 912a-d and/or the control center 914 focuses on optimizing load distribution (within each component and/or within the whole system 900) based on available resources. In some embodiments, the controllers/sensors 912a-d and/or the control center 914 use linear or nonlinear programming methods to define objective functions (e.g., cost minimization, emission reduction, maximum stability) while incorporating operational constraints (e.g., generation capacity, energy storage charge/discharge rates) in order to determine where, when and how much energy to generate, store, transmit (for each component of the system 900). In some embodiments, the controllers/sensors 912a-d and/or the control center 914 have a user interface that enables user input (to determine control of the component/system) via a large language model to control desired power usage (e.g., I want to minimize my utility costs, or my fridge cannot have power outage unless the costs is higher than 1.21 USD/day). In such embodiments, the controllers/sensors 912a-d and/or the control center 914 are able to comprise and/or be associated with an application and/or website that provides said user interface. The application is able to be downloadable onto a computing device (e.g. phone, laptop) and/or a part of the controllers/sensors 912a-d and/or the control center 914 itself.

As a result, the system 900 provides the benefit of both providing a top-level management system that develops overall power dispatch strategies based on real-time demand as well as edge-based management/control (via the controllers/sensors 912a-d) that enables quick responses and localized optimizations at the regional level, reducing delays and improving system stability. Further, the system 900 enables Incorporates Demand Side Management (DSM) to activate distributed load response as needed for balancing as well as decentralized control strategies utilizing autonomous control mechanisms to maintain local and overall stability even in cases of communication delays or partial node failures.

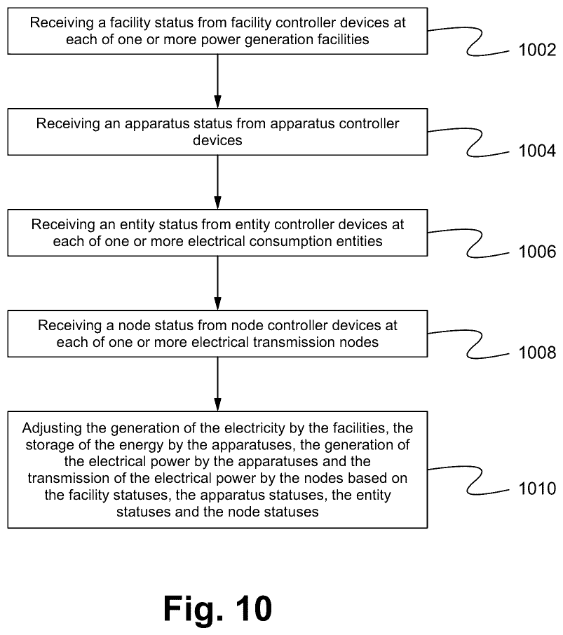

FIG. 10 illustrates a method of operating a virtual power plant system according to some embodiments. As shown in FIG. 10, the virtual power plant control center 914 receives a power generation facility status from facility controller devices 912a at each of one or more power generation facilities 902a-d at the step 1002. The virtual power plant control center 914 receives a power storage apparatus status from apparatus controller devices 912b at each of one or more energy storage apparatuses 904 at the step 1004. The virtual power plant control center 914 receives a power consuming entity status from entity controller devices 912d at each of one or more electrical consumption entities 910a-c at the step 1006. The virtual power plant control center 914 receives a transmission network node status from node controller devices at each of one or more electrical transmission nodes 908, 909 at the step 1008. The virtual power plant control center 914 adjusts the generation of the electricity by the facilities 902a-d, the storage of the energy by the apparatuses 904, the generation of the electrical power by the apparatuses 904 and the transmission (e.g. route of power through the network 906) of the electrical power by the nodes 908, 909 based on the facility statuses, the apparatus statuses, the entity statuses and the node statuses.

In some embodiments, the method further comprises the virtual power plant control center 914 utilizing artificial intelligence to predict future electrical power demand at one or more of the entities 910a-c and future electrical power generation capacity at one or more of the facilities 902a-d and the apparatuses 904 based on one or more of the facility statuses, the apparatus statuses, the entity statuses and the node statuses. In some embodiments, the adjusting of: the generation of the electricity by the facilities 902a-d, the storage of the energy by the apparatuses 904, the generation of the electrical power by the apparatuses 904 and the transmission of the electrical power by the nodes 908, 909, is based on at least one of the predicted future electrical power demand and the predicted future electrical power generation capacity. In some embodiments, the adjusting of the generation of the electricity by the facilities 902a-d, the storage of the energy by the apparatuses 904, the generation of the electrical power by the apparatuses 904 and the transmission of the electrical power by the nodes 908, 909, comprises minimizing transmission distance to reduce electrical power loss. In some embodiments, the adjusting of the generation of the electricity by the facilities 902a-d, the storage of the energy by the apparatuses 904, the generation of the electrical power by the apparatuses 904 and the transmission of the electrical power by the nodes 908, 909, comprises prioritizing a subset of the entities 910a-c such that the subset (is routed power by the nodes 908, 909 and) receives power even when there is insufficient electrical power for all of the entities 910a-c. In some embodiments, the method further comprises controlling each of the facilities 902a-d with facility controllers 912a (e.g. based on local sensing, processing, AI and/or other commands of the controllers 912a), controlling each of the apparatuses 904 with the apparatus controllers 912b (e.g. based on local sensing, processing, AI and or other commands of the controllers 912b), controlling each of the nodes 908. 909 with the node controllers 912c (e.g. based on local sensing, processing, AI and or other commands of the controllers 912c) and controlling each of the entities 910a-c with the entity controllers 912d (e.g. based on local sensing, processing, AI and or other commands of the controllers 912d) independent of commands received from the virtual power plant control center 914.

The present invention has been disclosed in preferred embodiments above, but those skilled in the art should understand that this embodiment is only used to describe the present invention and should not be construed as limiting the scope of the present invention. It should be noted that all changes and substitutions equivalent to this embodiment should be included in the scope of the present invention. Therefore, the protection scope of the present invention shall be defined by the scope of the patent application. For example, in some embodiments, one or more of the power generation facilities 902a-d are able to comprise some or all of the energy storage system 106. In some embodiments, one or more of the power storage apparatuses 904 are able to comprise the energy storage system 106. In such embodiments, the apparatus controller 912b is able to comprise the controller 38. In some embodiments, the electrical power transmission network 906 is able to comprise some or all of the energy transmitting system 108. In some embodiments, the virtual power plant control center 914 is able to comprise the control system 102. In some embodiments, wherein one or more of the controllers/sensors 912b are able to be the controller 38 of one or more of the apparatuses 904. Further, in some embodiments, one or more of the apparatuses 904 are able to have multiple controllers/sensors 912b that are dedicated to only one or a subset of the units of that apparatus 904. In such embodiments, the control center 914 is able to send commands that control operation of all, subsets of and/or one of the units at each of the apparatuses 904.

What is claimed is:

1. A virtual power plant system, the system comprising:
one or more energy storage apparatuses, wherein each of the energy storage apparatuses is configured to store an amount of received electricity by pumping a corresponding amount of fluid to increase a gas pressure inside the energy storage apparatus and to release a portion or all of the amount of received electricity by pushing out a portion or all of the corresponding amount of fluid to generate an amount of released electricity by driving a hydrogenerator; and
an energy distribution and controlling system dynamically and selectively controlling modes of electricity storing or electricity generating of a selected one or more of the one or more energy storage apparatuses based on an electricity consumption status.

2. The system of claim 1, further comprising one or more power generation facilities for generating electricity coupled to the one or more energy storage apparatuses to deliver the electricity to the energy storage apparatuses, wherein each of the power generation facilities includes a facility controller device that senses a facility status of the power generation facility.

3. The system of claim 2, wherein each of the one or more energy storage apparatuses comprise:
a first fluid container for accommodating a liquid and a gas;
a pump configured to pump the liquid into the first fluid container to compress the gas in the first fluid container using the electricity thereby storing energy;
a hydrogenerator driven by the liquid coming out from the first fluid container to generate electrical power using the stored energy; and
an apparatus controller for sensing an apparatus status of the energy storage apparatus;
one or more electrical consumption entities each including an entity controller for sensing an entity status of the electrical consumption entity.

4. The system of claim 3, further comprising one or more electrical transmission nodes each including a node controller for sensing a node status of the electrical transmission node and electrically coupled between the one or more energy storage apparatuses and the one or more electrical consumption entities for receiving the electrical power from the apparatuses and transmitting the electrical power to the one or more electrical consumption entities.

5. The system of claim 4, further comprising a virtual power plant control center communicatively coupled with each of the facility controller devices, the apparatus controllers, the entity controllers and the node controllers for receiving the facility statuses, the apparatus statuses, the entity statuses and the node statuses, wherein the control center adjusts the generation of the electricity by the power generation facilities, the storage of the energy by the one or more energy storage apparatuses, the generation of the electrical power by the one or more energy storage apparatuses and the transmission of the electrical power by the one or more electrical transmission nodes based on the facility statuses, the apparatus statuses, the entity statuses and the node statuses.

6. The system of claim 2, wherein the power generation facilities include one or more of a wind electric power generator, a water electric power generator, a solar electric power generator, and a heat electric power generator.

7. The system of claim 3, wherein the one or more electrical consumption entities include one or more of an industrial plant, a commercial center, and a residential area.

8. The system of claim 4, wherein the one or more electrical nodes include one or more of a distribution transformer, an electrical substation, and an electrical transmission tower.

9. The system of claim 5, wherein the virtual power plant control center utilizes artificial intelligence to predict future electrical power demand at one or more of the electrical consumption entities and future electrical power generation capacity at one or more of the power generation facilities and the one or more energy storage apparatuses based on one or more of the facility statuses, the apparatus statuses, the entity statuses and the node statuses.

10. The system of claim 9, wherein the virtual power plant control center adjusts the generation of the electricity by the power generation facilities, the storage of the energy by the one or more energy storage apparatuses, the generation of the electrical power by the one or more energy storage apparatuses and the transmission of the electrical power by the one or more electrical transmission nodes based on at least one of the predicted future electrical power demand and the predicted future electrical power generation capacity.

11. The system of claim 10, wherein when adjusting the generation of the electricity by the power generation facilities, the storage of the energy by the one or more energy storage apparatuses, the generation of the electrical power by the one or more energy storage apparatuses and the transmission of the electrical power by the one or more electrical transmission nodes, the virtual power plant control center minimizes transmission distance to reduce electrical power loss.

12. The system of claim 10, wherein when adjusting the generation of the electricity by the power generation facilities, the storage of the energy by the one or more energy storage apparatuses, the generation of the electrical power by the one or more energy storage apparatuses and the transmission of the electrical power by the one or more electrical transmission nodes, the virtual power plant control center prioritizes a subset of the one or more electrical consumption entities such that the subset receives power even when there is insufficient electrical power for all of the one or more electrical consumption entities.

13. The system of claim 9, wherein each of the facility statuses include one or more of whether the facility is currently operational and a current electrical power generation capacity of the facility.

14. The system of claim 9, wherein each of the apparatus statuses include one or more of whether the energy storage apparatus is currently operational, a current quantity of stored energy of the energy storage apparatus and a current electrical power generation capacity of the energy storage apparatus.

15. The system of claim 9, wherein the entity statuses include one or more of whether the electrical consumption entity is currently operational, a current electrical load of the electrical consumption entity, a current quantity of stored energy of the electrical consumption entity and a current electrical power demand of the electrical consumption entity.

16. The system of claim 9, wherein the node statuses include one or more of whether the electrical transmission node is currently operational, a current electrical load of the electrical transmission node, a current quantity of stored energy of the electrical transmission node and a current electrical power demand of the electrical transmission node.

17. The system of claim 5, wherein each of the facility controller devices is able to control the power generation facility, each of the apparatus controllers is able to control the energy storage apparatus, each of the node controllers is able to control the electrical transmission node and each of the entity controllers is able to control the electrical consumption entity independent of commands received from the virtual power plant control center.

18. A method of operating a virtual power plant system, the method comprising:
storing an amount of received electricity by pumping a corresponding amount of fluid to increase a gas pressure inside one or more energy storage apparatuses;
releasing a portion or all of the amount of received electricity by pushing out a portion or all of the corresponding amount of fluid to generate an amount of released electricity by driving a hydrogenerator; and
dynamically and selectively controlling modes of electricity storing or electricity generating with an energy distribution and controlling system of a selected one or more of the one or more energy storage apparatuses based on an electricity consumption status.

19. The method of claim 18, further comprising:
receiving, with a virtual power plant control center, a facility status from facility controller devices at each of one or more power generation facilities for generating electricity and delivering the electricity to the one or more energy storage apparatuses.

20. The method of claim 19, further comprising:
receiving, with the virtual power plant control center, an apparatus status from apparatus controller devices at each of the one or more energy storage apparatuses electrically coupled with the one or more power generation facilities for receiving the electricity generated by the one or more power generation facilities, wherein each of the one or more energy storage apparatuses comprise:
a first fluid container for accommodating a liquid and a gas;
a pump configured to pump the liquid into the first fluid container to compress the gas in the first fluid container using the electricity thereby storing energy; and
a hydrogenerator driven by the liquid coming out from the first fluid container to generate electrical power using the stored energy.

21. The method of claim 20, further comprising:
receiving, with the virtual power plant control center, an entity status from entity controller devices at each of one or more electrical consumption entities;
receiving, with the virtual power plant control center, a node status from node controller devices at each of one or more electrical transmission nodes electrically coupled between the one or more energy storage apparatuses and the one or more electrical consumption entities for receiving the electrical power from the one or more energy storage apparatuses and transmitting the electrical power to the one or more electrical consumption entities; and
adjusting the generation of the electricity by the one or more power generation facilities, the storage of the energy by the one or more energy apparatuses, the generation of the electrical power by the one or more energy storage apparatuses and the transmission of the electrical power by the one or more electrical transmission nodes with the virtual power plant control center based on the facility statuses, the apparatus statuses, the entity statuses and the node statuses.

22. The method of claim 21, wherein the one or more power generation facilities include one or more of a wind electric power generator, a water electric power generator, a solar electric power generator, and a heat electric power generator.

23. The method of claim 21, wherein the one or more electrical consumption entities include one or more of an industrial plant, a commercial center, and a residential area.

24. The method of claim 21, wherein the one or more electrical transmission nodes include one or more of a distribution transformer, an electrical substation, and an electrical transmission tower.

25. The method of claim 21, further comprising utilizing artificial intelligence with the virtual power plant control center to predict future electrical power demand at one or more of the electrical consumption entities and future electrical power generation capacity at one or more of the power generation facilities and the one or more energy storage apparatuses based on one or more of the facility statuses, the apparatus statuses, the entity statuses and the node statuses.

26. The method of claim 25, wherein the adjusting of, the generation of the electricity by the power generation facilities, the storage of the energy by the energy storage apparatuses, the generation of the electrical power by the energy storage apparatuses and the transmission of the electrical power by the electrical transmission nodes, is based on at least one of the predicted future electrical power demand and the predicted future electrical power generation capacity.

27. The method of claim 26, wherein the adjusting of the generation of the electricity by the power generation facilities, the storage of the energy by the energy storage apparatuses, the generation of the electrical power by the energy storage apparatuses and the transmission of the electrical power by the electrical transmission nodes, comprises minimizing transmission distance to reduce electrical power loss.

28. The method of claim 26, wherein the adjusting of the generation of the electricity by the power generation facilities, the storage of the energy by the energy storage apparatuses, the generation of the electrical power by the energy storage apparatuses and the transmission of the electrical power by the electrical transmission nodes, comprises prioritizing a subset of the one or more electrical consumption entities such that the subset receives power even when there is insufficient electrical power for all of the electrical consumption entities.

29. The method of claim 25, wherein each of the facility statuses include one or more of whether the power generation facility is currently operational and a current electrical power generation capacity of the power generation facility.

30. The method of claim 25, wherein each of the apparatus statuses include one or more of whether the energy storage apparatus is currently operational, a current quantity of stored energy of the energy storage apparatus and a current electrical power generation capacity of the energy storage apparatus.

31. The method of claim 25, wherein the entity statuses include one or more of whether the electrical consumption entity is currently operational, a current electrical load of the electrical consumption entity, a current quantity of stored energy of the electrical consumption entity and a current electrical power demand of the electrical consumption entity.

32. The method of claim 25, wherein the node statuses include one or more of whether the electrical transmission node is currently operational, a current electrical load of the electrical transmission node, a current quantity of stored energy of the electrical transmission node and a current electrical power demand of the electrical transmission node.

33. The method of claim 21, further comprising controlling each of the one or more power generation facilities with facility controllers, controlling each of the energy storage apparatuses with the apparatus controllers, controlling each of the one or more electrical transmission nodes with the node controllers and controlling each of the one or more electrical consumption entities with the entity controllers independent of commands received from the virtual power plant control center.

34. A virtual power plant system, the system comprising:
a sensing and control network including one or more facility controllers, one or more apparatus controllers, one or more node controllers and one or more entity controllers, wherein each of the facility controllers sense a facility status of a power generation facility that generates electricity, each of the apparatus controllers sense an apparatus status of an energy storage apparatus that receives the electricity generated by the power generation facilities, each of the entity controllers sense an entity status of an electrical consumption entity, and each of the node controllers sense a node status of an electrical transmission node for receiving the electrical power from one of the apparatuses and transmitting the electrical power to one of the electrical consumption entities; and
a virtual power plant control center communicatively coupled with the sensing and control network for receiving the facility statuses, the apparatus statuses, the entity statuses and the node statuses, wherein the control center adjusts the generation of the electricity by the power generation facilities, the storage of the energy by the energy storage apparatuses, the generation of the electrical power by the energy storage apparatuses and the transmission of the electrical power by the electrical transmission nodes based on the facility statuses, the apparatus statuses, the entity statuses and the node statuses;
wherein each of the energy storage apparatuses comprise:
a first fluid container for accommodating a liquid and a gas;
a pump configured to pump the liquid into the first fluid container to compress the gas in the first fluid container using the electricity thereby storing energy; and
a hydrogenerator driven by the liquid coming out from the first fluid container to generate electrical power using the stored energy.

35. The system of claim 34, wherein the power generation facilities include one or more of a wind electric power generator, a water electric power generator, a solar electric power generator, and a heat electric power generator.

36. The system of claim 34, wherein the electrical consumption entities include one or more of an industrial plant, a commercial center, and a residential area.

37. The system of claim 34, wherein the electrical transmission nodes include one or more of a distribution transformer, an electrical substation, and an electrical transmission tower.

38. The system of claim 34, wherein the virtual power plant control center utilizes artificial intelligence to predict future electrical power demand at one or more of the electrical consumption entities and future electrical power generation capacity at one or more of the power generation facilities and the energy storage apparatuses based on one or more of the facility statuses, the apparatus statuses, the entity statuses and the node statuses.

39. The system of claim 38, wherein the virtual power plant control center adjusts the generation of the electricity by the power generation facilities, the storage of the energy by the energy storage apparatuses, the generation of the electrical power by the energy storage apparatuses and the transmission of the electrical power by the electrical transmission nodes based on at least one of the predicted future electrical power demand and the predicted future electrical power generation capacity.

40. The system of claim 39, wherein when adjusting the generation of the electricity by the power generation facilities, the storage of the energy by the energy storage apparatuses, the generation of the electrical power by the energy storage apparatuses and the transmission of the electrical power by the electrical transmission nodes, the virtual power plant control center minimizes transmission distance to reduce electrical power loss.

41. The system of claim 39, wherein when adjusting the generation of the electricity by the power generation facilities, the storage of the energy by the energy storage apparatuses, the generation of the electrical power by the energy storage apparatuses and the transmission of the electrical power by the electrical transmission nodes, the virtual power plant control center prioritizes a subset of the electrical consumption entities such that the subset receives power even when there is insufficient electrical power for all of the electrical consumption entities.

42. The system of claim 38, wherein each of the facility statuses include one or more of whether the power generation facility is currently operational and a current electrical power generation capacity of the power generation facility.

43. The system of claim 38, wherein each of the apparatus statuses include one or more of whether the energy storage apparatus is currently operational, a current quantity of stored energy of the energy storage apparatus and a current electrical power generation capacity of the energy storage apparatus.

44. The system of claim 38, wherein the entity statuses include one or more of whether the electrical consumption entity is currently operational, a current electrical load of the electrical consumption entity, a current quantity of stored energy of the electrical consumption entity and a current electrical power demand of the electrical consumption entity.

45. The system of claim 38, wherein the node statuses include one or more of whether the electrical transmission node is currently operational, a current electrical load of the electrical transmission node, a current quantity of stored energy of the electrical transmission node and a current electrical power demand of the electrical transmission node.

46. The system of claim 34, wherein each of the facility controllers is able to control the power generation facility, each of the apparatus controllers is able to control the energy storage apparatus, each of the node controllers is able to control the electrical transmission node and each of the entity controllers is able to control the electrical consumption entity independent of commands received from the virtual power plant control center.
